(19) United States
(12) Patent Application Publication
(10) Pub. No.: US 2018/0128897 A1
(43) Pub. Date: May 10, 2018

(54) SYSTEM AND METHOD FOR TRACKING THE POSITION OF AN OBJECT

(71) Applicant: BreqLabs Inc., Toronto (CA)

(72) Inventor: Martin Labrecque, Toronto (CA)

(21) Appl. No.: 15/489,172

(22) Filed: Apr. 17, 2017

Related U.S. Application Data
(60) Provisional application No. 62/418,790, filed on Nov. 8, 2016.

(51) Int. Cl. G01S 5/30; G06F 1/16

(52) U.S. Cl. CPC G01S 5/30; G06F 1/163

(57) ABSTRACT

The present invention is a system and method for determining the position of a transmitter relative to a receiver using ultrasound. The transmitter emits an ultrasonic sound pulse provide an indication of the time of emission of the sound electronically. A computer processor receives the time indication from the transmitter and three ultrasonic receivers positioned in a fixed arrangement. The receivers are not positioned collinearly and are spaced apart from each other by less than two times the wavelength of the sound. The computer processor estimates the relative position of the transmitter based on the time indication and time of flight of the ultrasonic sound to each of the three receivers. In preferred embodiments, the receivers are spaced apart from each other by less than the wavelength of the sound.

### FIELD OF THE INVENTION

The invention relates in general to systems for tracking the position of an object, and in particular to systems for tracking the position of an object using ultrasound. It also relates to input device and user interfaces (UIs) and the fields of natural, adaptable and wearable user interfaces, as well as methods for data acquisition and processing.

### BACKGROUND OF THE INVENTION

There exist headsets that can immerse a viewer into a virtual environment. This environment can be rendered from a tethered (or wirelessly) connected computer or from a computing device embedded in the headset. It is important to know the position of the viewer for the computing device to be able to change the viewer's position in the virtual world, therefore allowing the view to move in the virtual world. It is also important to know the position of the user's hands, handheld instruments and of some other real objects to allow the user to interact with them. There exist tracking systems (for example, the Microsoft Kinect™, or the HTC Vive™), that can track a user within a limited volume. They usually require a device that is static and installed in the room, and often rely on computer vision to track the user in the room. These approaches do not work well in cases of very large rooms where the user can move or it is not practical for the user to carry and install a tracking device in the room. Computer vision also requires intensive processing capacity.

### SUMMARY OF THE INVENTION

The following presents a simplified summary of the disclosure in order to provide a basic understanding to the reader. This summary is not an extensive overview of the disclosure and it does not necessarily identify key/critical elements of the invention or delineate the scope of the invention. Its sole purpose is to present some concepts disclosed herein in a simplified form as a prelude to the more detailed description that is presented later.

The present invention provides a system for determining the position of a transmitter relative to a receiver, The transmitter is configured to emit an ultrasonic sound having a wavelength and also to provide an indication of the time of emission of the sound. By ultrasonic sound, it is meant sound waves with frequencies higher than the upper audible limit of human hearing, which is typically about 20 kHz (i.e. 20,000 cycles per second).The system includes a computer processor configured to receive the time indication from the transmitter and three ultrasonic receivers positioned in a fixed arrangement. The receivers are not positioned collinearly, and they are spaced apart from each other by less than two times the wavelength of the sound. The receivers are in electronic communication with the computer processor. The computer processor is configured to estimate the relative position of the transmitter based on the time indication and time of flight of the ultrasonic sound to each of the three receivers.

The time of emission of the sounds may be provided by establishing a pre-determined time and the transmitter emitting the sound at that time, where the clocks of the transmitter and computer processor have been synchronized.

The receivers are preferably spaced apart from each other by less than the wavelength of the sound.

The sound may have a finite duration, or the sound may be modulated with a fixed modulation frequency.

The ultrasonic sound may be a pulse in a series of pulses and the computer processor may then be configured to estimate the relative position of the transmitter for each of the pulses.

The receivers are preferably positioned in a plane and spaced apart from each other by less than the wavelength of the sound.

The receivers and the computer processor may be connected to a printed circuit board that allows the computer processor to communicate with the receivers.

The first and second receivers may be spaced apart along a first line and the third receiver spaced apart from the first received along a second line perpendicular to the first line. The first line and second line may be equal in length,

The time of flight of the ultrasonic sound to each of the three receivers may be used by the computer processor to calculate the distances of the transmitter to each receiver and the distances then used to calculate the position of the transmitter. By time of flight, it is meant the time between the transmission of a portion of sound and the reception of that portion of the sound by the receiver Such time is typically measured in milliseconds in the present context.

The differences in the distances between the transmitter and each receiver may be calculated by the computer processor using phase unwrapping and used to calculate the distances of the transmitter to each receiver, and the distances may then be used to calculate the position of the transmitter.

The transmitter may be part of a hand-held device holdable by the user in one of the user's hands, and the receivers attached to a circuit board that is part of a head-mounted display wearable by the user.

The receivers may be part of a hand-held device holdable by the user in one of the user's hands, and the transmitter attached to a circuit board that is part of a head-mounted display wearable by the user.

The system of claim 1, wherein the ultrasound sound is a frequency modulated pulse modulated between a minimum and a maximum frequency corresponding to a maximum and a minimum wavelength respectively, wherein the receivers are spaced apart from each other by less than two times the maximum wavelength. The receivers may be spaced apart from each other by less than the minimum wavelength.

The invention also provides a method for determining the position of a transmitter relative to a receiver by a computer processor. The transmitter is configured to emit an ultrasonic sound having a wavelength. The transmitter also provides an indication of the time of emission of the sound. The computer processor is electronically connected to three ultrasonic receivers positioned in a fixed arrangement. The three receivers are not positioned collinearly. The receivers are spaced apart from each other by less than two times the wavelength of the sound. The computer processor is configured to perform the steps of the method. The computer processor receives the time indication from the transmitter, and, for each receiver, after the receiver has started to receive the ultrasonic sound, the computer processor receives from the receiver data obtained from the received sound. Then, the computer processor calculates the time of flight of the ultrasonic sound to each of the three receivers. Then, the computer processor calculates the relative position of the transmitter based on the time indication and the time of flight of the ultrasonic sound to each of the three receivers.

In such methods, the clocks of the transmitter and the computer processor may be synchronized, and the time indication from the transmitter may be the transmitter starting to transmit the sound at a pre-determined time.

In such methods the time of flight of the ultrasonic sound to each of the three receivers may be used by the computer processor to calculate the distances of the transmitter to each receiver and the distances used to calculate the position of the transmitter.

In such methods the differences in the distances between the transmitter and each receiver may be calculated by the computer processor using phase unwrapping and used to calculate the distances of the transmitter to each receiver and the distances then used to calculate the position of the transmitter.

In such methods the transmitter may be part of a hand-held device holdable by the user in one of the user's hands, and the receivers may be attached to a circuit board that is part of a head-mounted display wearable by the user.

In such methods the receivers may be part of a hand-held device holdable by the user in one of the user's hands, and the transmitter may be attached to a circuit board that is part of a head-mounted display wearable by the user.

In such methods the ultrasound sound may be a frequency modulated pulse modulated between a minimum and a maximum frequency corresponding to a maximum and a minimum wavelength respectively, and the receivers may be spaced apart from each other by less than two times the maximum wavelength.

### BRIEF DESCRIPTION OF THE DRAWINGS

FIG. 1 shows an example of a pulse of sound as received by a receiver.

FIG. 2. depict an object having a transmitter being tracked by three receivers.

FIG. 3 depicts a person wearing a head-mounted display that includes a transmitter holding a controller that includes a receiver system.

FIG. 4 depicts receiver circuitry.

FIG. 5 depicts an example showing how to measure the phase difference between two signals with repeating features.

FIG. 6a shows one side of a receiver system comprising a printed circuit board. FIG. 6b shows the other side of the receiver system of FIG. 6a.

### DETAILED DESCRIPTION OF THE INVENTION

The present invention is a system and method for determining the position of a transmitter 200, as depicted in FIG. 2, relative to a receiver 201 using ultrasound. The transmitter 200 emits an ultrasonic sound pulse and provides an indication of the time of emission of the sound. A computer processor receives the time indication and three ultrasonic receivers r1, r2, r3 positioned in a fixed arrangement receive the sound pulse. The receivers r1, r2, r3 are not positioned collinearly and are spaced apart from each other by less than two times the wavelength of the sound. The computer processor estimates the relative position of the transmitter based on the time indication and time of flight of the ultrasonic sound to each of the three receivers. In preferred embodiments, the receivers r1, r2, r3 are spaced apart from each other by less than the wavelength of the sound. The spacing of receivers as used herein refers to the distance from the center of the sensing element of one receiver to the center of the sensing element of another receiver. For example, the receivers may be positioned in a more or less triangular configuration relative to each other, as shown in FIG. 2, or in any other non-collinear arrangement.

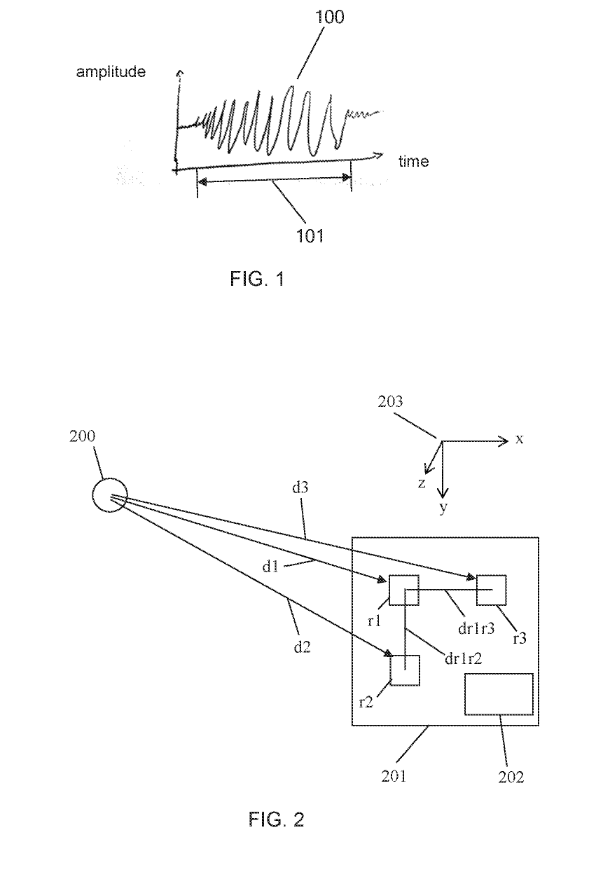

The transmitter emits an ultrasonic wave, which may be pulsed. The transmitter may emit a pulse of sound 100 having a finite duration 101, as shown in FIG. 1, or, for example, the sound may be modulated with a fixed modulation frequency to allow the receiving device to calculate the flight time of the sound, although it is not essential to employ a fixed modulation frequency. Where the sound is of a finite duration it may be pulsed, either with a regular frequency, or intermittently. The sound may be continuous, such as in embodiments where the sound is modulated, either with respect to frequency, phase or amplitude, or otherwise. The receiving device 201, as shown in FIG. 2, determines the time of flight (i.e. the time from transmitter/emitter to receiver) of this ultrasonic pulse. The transmitter provides an indication of the time of emission of the sound. This may be done, for example, by using a common clock and starting to emit the sounds at a predetermined time. Alternatively it may be done, for example, by the transmitter sending a wireless message, or an infrared synchronization signal). For example, the transmitter may comprise an ultrasound transducer electronically connected to and controlled by a computer processor and the computer processor electronically transmits the time indication(s).

The signal could be pulsed, possibly using pulse compression and a variety of frequency, phase shifts and amplitudes to allow a receiver to best identify the alignment between multiple recordings of a single pulse. The pulses may also have varying features (pulse length, frequency, phase shifts and amplitudes) to allow a receiver system to periodically or at given instants perform some computations or calibrations attenuating or preventing discrepancies between the calculated position and the actual position. Such pulse coding techniques, which can be useful to enhance the accuracy of time of flight estimates, are well known in the art.

The emitting device 200 may optionally be equipped with multiple ultrasonic emitting devices to increase the range or coverage of the ultrasonic pulse, although only one transmitter 200 is required.

More than one time of flight can be recovered for the same pulse by using more than one receiver. With this time of flight information, trilaeration or multi-lateration can be computed to determine the position of the receiver, which may be attached to a wearable device. Trilaeration and Multilateration are well known techniques in general to skilled persons.

To obtain high accuracy, in the prior art, the sensors are normally located outside of the maximum position of the tracked object and not be placed in a line.

FIG. 2. shows an embodiment of the receiving device 201 having three receivers r1, r2, r3 and a computer processor 202 (i.e. microcontroller). In this embodiment, the receivers r1, r2, r3 are all located in a plane, being the x-y plane as indicated by axes 203. Receivers r1 and r3, or more precisely the centers of the sensing elements of the receivers r1 and r3, are spaced apart by a distance dr1r3 along a first line parallel to the x axis. Receivers r1 and r2, or more precisely the centers of the receivers r1 and r2, are spaced apart by a distance dr1r2 along a second line parallel to the y axis. In this embodiment, the first and second lines are perpendicular, which simplifies certain calculations, but this is not required. The primary constraint on the three receivers r1, r2, r3 is that they not lie on the same line, i.e. that they not be collinearly positioned. More than three receivers may be employed, which may allow improved accuracy of the estimate of the relative position of the transmitter, but three is the minimum number required.

The relative position of the transmitter is the position of the transmitter in a coordinate system that is fixed with respect to the receiving device 201. In this example, we assume that the origin of the three-dimensional Euclidean coordinate system 203 is at the centre of r1 (the particular location of the origin is of course arbitrary). The receiving system 201 employs a printed circuit board, which is planar and lies in the x-y plane in FIG. 2. In FIG. 2, the x-y plane is assumed to correspond to the sheet on which the figure is drawn. The z axis is perpendicular to the x-y plane and drawing sheet. The transmitter does not lie in the x-y plane (i.e. is not coplanar with the receivers, and so has a non-zero z coordinate value) and may move over time relative to the receiving device 201 so that the coordinates of the transmitter 200 change over time.

The distances d1, d2, d3 between the transmitter 200 and the receivers r1, r2, r3 respectively can be computed based on the time of flight of an ultrasound pulse from the transmitted to each receiver. Based on these distances, the computer processor 202 can then calculate the coordinates, Xt, Yt and Zt, defining the relative position of the transmitter 200. In this case, the coordinates may be calculated as follows,

Xt (d3²±dr1r3²−d1²)/(2*dr1r3).

Yt˜=(d2²+dr1r2²−d1²)/(2*dr1r2

Zt˜=+/−sqrt(d1²−(Xt²+Yt²).

The system may include another type of sensor (such as an inertial measurement unit) and may analyze the trajectory of the transmitter to resolve the ambiguity in Zt.

In preferred embodiments, dr1r3 and dr1r2 are each less than two times the wavelength of the sound, and more preferably less than the wavelength. Noting that the wavelength may vary if the pulse in modulated, the “wavelength” for purposes of this constraint can be taken to be the maximum wavelength.

Since dr1r3 and dr1r2 are relatively small compared to d1, d2 and d3, it is evident that the above calculation of Xt, Yt, Zt has a low signal to noise ratio and so may be relatively inaccurate.

In addition to only measuring the time of arrival of the sound wave, the system also preferably measures the relative time spacing between the three received signals. So, for example, rather than measuring d1, d2 and d3 independently, the system measures di and then calculates d2 32 di+Δd1d2, and d3=d1+Δd1d3, where Δd1d2 and Δd1d3 are calculated by measuring the phase differences between the pulses received by d1 and d2 and the pulses received by d1 and d3 respectively. This way, the calculation of the distances d1, d2, and d3 do not have three unrelated sources of error. Indeed, measuring the relation between the signals can be less noisy than measuring an overall time of arrival.

This is analogous to comparing sine waves. Measuring their relative time spacing equates to measuring their relative phase distance. Because they are periodic, there is an uncertainty regarding which periods are aligned. So the phase distance can be computed with a 2*π uncertainty, corresponding to a wavelength (the distance that the wave travels during the time corresponding to the inverse of its frequency). For example, d3=d1+Δd1d3 where Δd1d3 is the distance corresponding to the phase difference (Δ_{φ13}) of the signal received at r1 and r3, plus or minus an integer number of wavelengths W, i.e. Δd1d3=Δ_{φ13}+n*λ, where n is an integer and λ is the wavelength. Similarly Δd1d2=Δ_{φ12}+m*λ, where m is an integer. Solving the uncertainty in the values of m and n is called phase unwrapping.

The receiver of the ultrasonic pulses may also keep track of the phase of the pulse across more than one ultrasonic receiver and determine when a phase wrap happens. This information can be used to determine the difference of distance between the ultrasonic emitter and each receiver, thus allowing to recover the position of the emitter, which may be attached to, or part of a wearable device.

Placing receiver pairs at a center-to-center distance of less than two wavelengths helps to reduce uncertainty when determining the phase difference between two or more recordings of the same pulse. In the previous equations, Δd1d3=Δ_{φ13}+n*λ and Δd1d2=Δ_{φ12}+m*λ, m and n are then limited to 0, −1 and +1 values in almost all scenarios pertaining to a short tracked distance, on the order of an arm's length (e.g. 1 m).

To further resolve this ambiguity, it is very preferable to have the ultrasonic sensors placed at less than an ultrasonic wavelength apart, or have an alternate set of ultrasonic sensors placed at less than an ultrasonic wavelength apart to prevent this ambiguity from happening in a given movement range. In the case where a secondary set of ultrasonic sensors is used, they could provide the necessary information for phase unwrapping and they could also be used to smooth, filter or augment of the primary set of ultrasonic sensors. Then, in the previous equations, Δd1d3=Δ_{φ13}+n*λ and Δd1dd2=Δ_{φ12}+m*λ, m and n are then limited to 0 in most common scenarios pertaining to a short tracked distance, on the order of an arm's length. Using a secondary set of receivers used for phase unwrapping applies to any configuration of the primary set of receivers.

By placing the receivers less than one wavelength apart, the uncertainty is either eliminated or is infrequent, which is a significant advantage over approaches where the receivers are spaced apart by more than one wavelength. This is only possible with very small sensors, which are not typically used for ultrasonic sensing in air. The receivers r1, r2, r3 must be sufficiently small that the center to center distance of their sensing elements is less than one wavelength, which generally means that one or more of the dimensions of each receiver must be less than one wavelength. For suitable choices of ultrasonic wavelength, such receivers are commercially available. The use of closely located receivers is considered counterintuitive because to obtain high accuracy, in the prior art, the sensors are normally located outside of the maximum position of the tracked object, or if that is not possible, as far as possible.

One embodiment of a receiver includes the following elements, as exemplified in FIG. 4,

An ultrasonic receiver 400 feeds into a filtering stage 410 and an amplification stage 420 and into an analog to digital conversion stage 440. The analog to digital conversion stage may have a varying resolution. For simplicity, only 1 bit may be used by implementing a comparator 430. Lastly, there is a timer circuit 440 that times the samples coming from the analog to digital conversion stage. This timer circuit may be part of the microcontroller. The timer circuit has a start signal that may originate from the reception of a radio packet sent wirelessly. Part or all of the receiving circuitry can be built out of a single or multiple pieces of circuitry, including the use of software programmable elements.

A preferred algorithm will now be described as a series of steps.

Step 1—Estimate the time of flight d1 directly based on the time indication.

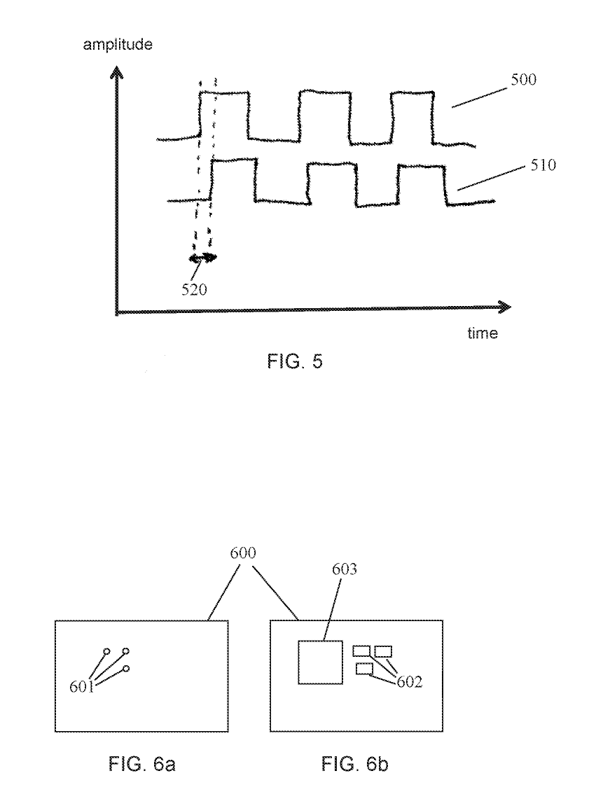

Step 2—Measure the distance corresponding to the phase difference (Δ_{φ12}) between d1 and d2 with no uncertainty, as exemplified in FIG. 5. In FIG. 5, two waveforms converted into digital signals with a 1 bit resolution (500 and 510) are depicted (Note that the waveforms have approximately the same amplitude profiles). The phase difference 520 is simply the difference in time between two consecutive edges of each waveform. The distance corresponding to this time is obtained by multiplying the time by the speed of sound. Obtain a preliminary version of d2 by adding this distance (Δ_{φ12}) to d1.

Step 3—Measure the distance corresponding to the phase difference (Δ_{φ13}) between d1 and d3 with no uncertainty, as exemplified in FIG. 5. Proceed as in step 2.

Step 4—Use phase tracking if the tracked object is near to a phase wrap boundary; otherwise use the preliminary versions of d2 and d3 as the estimates of d2 and d3. Phase tracking is defined as keeping a minimum history of values to determine if the wrapped phase rolled over from −π to +π, or +π to −π, and apply the necessary correction to the distance corresponding to the phase difference. So d2 for example could be d1+phase offset distance (Δ_{φ12})+/−wavelength (λ).

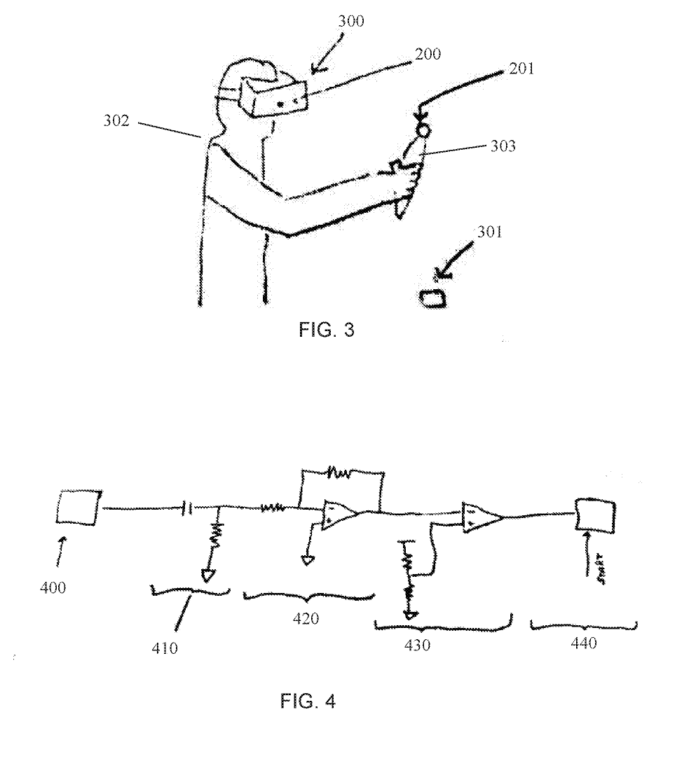

FIG. 3 shows an example of an application for the invention. In FIG. 3, a user 302 is wearing a head-mounted display 300 with an ultrasonic transmitter 200 on the front of the head-mounted display. The user 302 is holding a controller 303 with an ultrasonic receiver system 201. Alternatively the ultrasonic receiver system 201 could be attached to the head-mounted display 300 and the ultrasonic transmitter 200 be part of the controller 303. There may be more than one system of receivers on any unit to, for example, recover the orientation of that unit from the two measured positions, and knowing the orientation of the head mounted display from its internal inertial measurement unit. There may be other types of devices that have a receiver system, such as a marker 301 fixed in a room, gloves, etc. The head-mounted display may be a custom hardware component, or may include or consist of a mobile device, such as a smartphone. Likewise, the controller may be a custom hardware component or an adapted generic hardware component.

FIGS. 6a and 6b show front and rear views respectively of a receiver device comprising a printed circuit board 600 and three receivers 602 and a computer processor 603. The three receivers 602 are placed on one side of the board such that holes 601 through the board, one being aligned with each receiver, allow the sound to pass through the board to the receivers. Such an arrangement is appropriate, for example, for sensors that have a port on the side where they are soldered. Other types of sensors may read the ultrasound from the same side as where they are located.

As an example, consider an ultrasound signal with a frequency of 40 kHz. The wavelength is equal to the speed of the sound divided by its frequency. Assuming a 340 m/s speed of sound in ambient conditions, its wavelength would be 330/40000=0.00825 m, or 8.25 mm. Typical piezoelectric receivers tuned at 40 kHz have an external diameter of roughly 9 mm to allow the membrane to resonate at that frequency. Placing those receivers closer than a wavelength apart is not possible. Consider placing them at a center-to-center spacing of 9 mm to build example system A. If, for example, mi croelectromechanical system (MEMS) receivers are used instead, their package is much smaller because their operating principle is different so that they can be placed with the sensing elements having a center-to-center distance of 4 mm, for example, to build example system B.

For example, consider tracking an object located at, x=500 mm, y=500 mm, z=500 mm. In system A,

d1=sqrt(500*500*3)=866 mm, and

d2=sqrt((500+9)*(500+9)*2+500*500)=˜876 mm.

In system B,

d1=sqrt(500*500*3)=18 866 mm, and

d2=sqrt((500+4)*(500+4)*2+500*500)=˜871 mm.

It can thus be seen that in system A, d2 is more than one wavelength less than d1, which creates a phase uncertainty when comparing the two waveforms. in system B, that is not the case.

The tracking system described herein can be utilized for a wide range of applications. Only a few examples are mentioned herein for reference. In general, the tracked object or the tracker could be the one emitting the ultrasound signal, or receiving it or a combination of both.

Tracking can be applied to the hands of a user in a virtual reality system, to the head of a user in a virtual reality system, or a plurality of objects that need to be tracked for robotic, medical, etc. applications. In the case of tracking a user's hands, the receiver may be in a controller or controllers held by the user, as depicted in FIG. 3, or otherwise attached to the user's hands, such as via gloves, or transmitters may be so placed in association with the user's hands. The arrangement has advantages over computer vision for multiple reasons, such as not requiring a clear visual line of sight, and for permitting the use of less computationally intensive processing.

In general, the position estimation described herein may be repeated over time to track the relative position of the transmitter over time. This may be done, for example, by having the transmitter transmit pulses periodically, or suitable modulating the transmitted sound periodically.

It should be noted that herein the relative position of the transmitter means the position of the transmitter in a coordinate system fixed with respect to the receiver. However, it is equivalent to determine the position of the receiver in a coordinate system fixed with respect to the transmitter.

It is noted that piezoelectric receivers may have a different bandwidth than MEMS receivers. Some embodiments may employ MEMS receivers closely spaced with respect to each other, and also a cluster of piezoelectric receivers in the vicinity, or a set of receivers that combines both MEMS and piezoelectric receivers with a center-to-center spacing of less than one or two wavelengths.

Generally, a computer, computer system, computing device, client or server, as will be well understood by a person skilled in the art, includes one or more than one electronic computer processor, and may include separate memory, and one or more input and/or output (I/O) devices (or peripherals) that are in electronic communication with the one or more processor(s). The electronic communication may be facilitated by, for example, one or more busses, or other wired or wireless connections. In the case of multiple processors, the processors may be tightly coupled, e.g. by high-speed busses, or loosely coupled, e.g. by being connected by a wide-area network.

A computer processor, or just “processor”, is a hardware device for performing digital computations. It is the express intent of the inventors that a “processor” does not include a human; rather it is limited to be an electronic device, or devices, that perform digital computations. A programmable processor is adapted to execute software, which is typically stored in a computer-readable memory. Processors are generally semiconductor based microprocessors/microcontrollers, in the form of microchips or chip sets. Processors may alternatively be completely implemented in hardware, with hard-wired functionality, or in a hybrid device, such as field-programmable gate arrays or programmable logic arrays. Processors may be general-purpose or special-purpose off-the-shelf commercial products, or customized application-specific integrated circuits (ASICs). Unless otherwise stated, or required in the context, any reference to software running on a programmable processor shall be understood to include purpose-built hardware that implements all the stated software functions completely in hardware.

Multiple computers (also referred to as computer systems, computing devices, clients and servers) may be networked via a computer network, which may also be referred to as an electronic network or an electronic communications network. When they are relatively close together the network may be a local area network (LAN), for example, using Ethernet. When they are remotely located, the network may be a wide area network (WAN), such as the internet, that computers may connect to via a modem, or they may connect to through a LAN that they are directly connected to.

Computer-readable memory, which may also be referred to as a computer-readable medium or a computer-readable storage medium, which terms have identical (equivalent) meanings herein, can include any one or a combination of non-transitory, tangible memory elements, such as random access memory (RAM), which may be DRAM, SRAM, SDRAM, etc., and nonvolatile memory elements, such as a ROM, PROM, FPROM, OTP NVM, EPROM, EEPROM, hard disk drive, solid state disk, magnetic tape, CDROM, DVD, etc.) Memory may employ electronic, magnetic, optical, and/or other technologies, but excludes transitory propagating signals so that all references to computer-readable memory exclude transitory propagating signals. Memory may be distributed such that at least two components are remote from one another, but are still all accessible by one or more processors. A nonvolatile computer-readable memory refers to a computer-readable memory (and equivalent terms) that can retain information stored in the memory when it is not powered. A computer-readable memory is a physical, tangible object that is a composition of matter. The storage of data, which may be computer instructions, or software, in a computer-readable memory physically transforms that computer-readable memory by physically modifying it to store the data or software that can later be read and used to cause a processor to perform the functions specified by the software or to otherwise make the data available for use by the processor. In the case of software, the executable instructions are thereby tangibly embodied on the computer-readable memory. It is the express intent of the inventor that in any claim to a computer-readable memory, the computer-readable memory, being a physical object that has been transformed to record the elements recited as being stored thereon, is an essential element of the claim.

Software may include one or more separate computer programs configured to provide a sequence, or a plurality of sequences, of instructions to one or more processors to cause the processors to perform computations, control other devices, receive input, send output, etc.

It is intended that the invention includes computer-readable memory containing any or all of the software described herein. In particular, the invention includes such software stored on non-volatile computer-readable memory that may be used to distribute or sell embodiments of the invention or parts thereof.

The abbreviation mm as used herein refers to millimetres (or in the US, “millimeters”). The abbreviation cm as used herein refers to centimetres (or in the US, “centimeters”).

Where, in this document, a list of one or more items is prefaced by the expression “such as” or “including”, is followed by the abbreviation “etc.”, or is prefaced or followed by the expression “for example”, or “e.g.”, this is done to expressly convey and emphasize that the list is not exhaustive, irrespective of the length of the list. The absence of such an expression, or another similar expression, is in no way intended to imply that a list is exhaustive. Unless otherwise expressly stated or clearly implied, such lists shall be read to include all comparable or equivalent variations of the listed item(s), and alternatives to the item(s), in the list that a skilled person would understand would be suitable for the purpose that the one or more items are listed. Unless expressly stated or otherwise clearly implied herein, the conjunction “or” as used in the specification and claims shall be interpreted as a non-exclusive “or” so that “X or Y” is true when X is true, when Y is true, and when both X and Y are true, and “X or Y” is false only when both X and Y are false.

The words “comprises” and “comprising”, when used in this specification and the claims, are to used to specify the presence of stated features, elements, integers, steps or components, and do not preclude, nor imply the necessity for, the presence or addition of one or more other features, elements, integers, steps, components or groups thereof.

It should be understood that the above-described embodiments of the present invention, particularly, any “preferred” embodiments, are only examples of implementations, merely set forth for a clear understanding of the principles of the invention. Many variations and modifications may be made to the above-described embodiment(s) of the invention as will be evident to those skilled in the art. That is, persons skilled in the art will appreciate and understand that such modifications and variations are, or will be, possible to utilize and carry out the teachings of the invention described herein.

The scope of the claims that follow is not limited by the embodiments set forth in the description. The claims should be given the broadest purposive construction consistent with the description and figures as a whole.

What is claimed is:

1. A system for determining the position of a transmitter relative to a receiver, the transmitter being configured to emit an ultrasonic sound having a wavelength and to provide an indication of the time of emission of the sound, the system comprising a computer processor configured to receive the time indication from the transmitter and three ultrasonic receivers positioned in a fixed arrangement and not positioned col linearly, the receivers being spaced apart from each other by less than two times the wavelength of the sound, the receivers being in electronic communication with the computer processor, wherein the computer processor is configured to estimate the relative position of the transmitter based on the time indication and time of flight of the ultrasonic sound to each of the three receivers.

2. The system of claim 1, wherein the receivers are spaced apart from each other by less than the wavelength of the sound.

3. The system of claim 1, wherein the sound has a finite duration.

4. The system of claim 1, wherein the sound is modulated with a fixed modulation frequency.

5. The system of claim 1, wherein the ultrasonic sound is a pulse in a series of pulses and the computer processor is configured to estimate the relative position of the transmitter for each of the pulses.

6. The system of claim 1, wherein the receivers wherein the receivers are positioned in a plane and are spaced apart from each other by less than the wavelength of the sound.

7. The system of claim 1, wherein the receivers and the computer processor are connected to a printed circuit board that allows the computer processor to communicate with the receivers.

8. The system of claim 1, wherein the first and second receivers are spaced apart along a first line and the third receiver is spaced apart from the first received along a second line perpendicular to the first line, and the first line and second line are equal in length.

9. The system of claim 1, wherein the time of flight of the ultrasonic sound to each of the three receivers is used by the computer processor to calculate the distances of the transmitter to each receiver and the distances are used to calculate the position of the transmitter.

10. The system of claim 1, wherein the differences in the distances between the transmitter and each receiver are calculated by the computer processor using phase unwrapping and used to calculate the distances of the transmitter to each receiver and the distances are used to calculate the position of the transmitter.

11. The system of claim 1, wherein the transmitter is part of a hand-held device holdable by the user in one of the user's hands, and the receivers are attached to a printed circuit board that is part of a head-mounted display wearable by the user.

12. The system of claim 1, wherein the receivers are is part of a hand-held device holdable by the user in one of the user's hands, and the transmitter is attached to a circuit board that is part of a head-mounted display wearable by the user.

13. The system of claim 1, wherein the ultrasound sound is a frequency modulated pulse modulated between a minimum and a maximum frequency corresponding to a maximum and a minimum wavelength respectively, wherein the receivers are spaced apart from each other by less than two times the maximum wavelength.

14. A method for determining the position of a transmitter relative to a receiver by a computer processor, the transmitter being configured to emit an ultrasonic sound having a wavelength and to provide an indication of the time of emission of the sound, the computer processor being electronically connected to three ultrasonic receivers positioned in a fixed arrangement and not positioned collinearly, the receivers being spaced apart from each other by less than two times the wavelength of the sound, the computer processor being configured to perform the steps of:
receiving the time indication from the transmitter;
for each receiver, after the receiver has started to receive the ultrasonic sound, receiving from the receiver data obtained from the received sound;
calculating time of flight of the ultrasonic sound to each of the three receivers;
calculating the relative position of the transmitter based on the time indication and the time of flight of the ultrasonic sound to each of the three receivers.

15. The method of claim 14, wherein clocks of the transmitter and the computer processor are synchronized, and the computer processor receives the time indication from the transmitter by the transmitter starting to transmit the sound at a pre-determined time.

16. The method of claim 14, wherein the time of flight of the ultrasonic sound to each of the three receivers is used by the computer processor to calculate the distances of the transmitter to each receiver and the distances are used to calculate the position of the transmitter.

17. The method of claim 14, wherein the differences in the distances between the transmitter and each receiver are calculated by the computer processor using phase unwrapping and used to calculate the distances of the transmitter to each receiver and the distances are used to calculate the position of the transmitter.

18. The method of claim 14, wherein the transmitter is part of a hand-held device holdable by the user in one of the user's hands, and the receivers are attached to a circuit board that is part of a head-mounted display wearable by the user.

19. The method of claim 14, wherein the receivers are is part of a hand-held device holdable by the user in one of the user's hands, and the transmitter is attached to a circuit board that is part of a head-mounted display wearable by the user.

20. The method of claim 14, wherein the ultrasound sound is a frequency modulated pulse modulated between a minimum and a maximum frequency corresponding to a maximum and a minimum wavelength respectively, wherein the receivers are spaced apart from each other by less than two times the maximum wavelength.
